(19) United States
(12) Patent Application Publication
(10) Pub. No.: US 2022/0037892 A1
(43) Pub. Date: Feb. 3, 2022

(54) ELECTRICAL ENERGY STORAGE SYSTEM MODULE LEVEL DIAGNOSTICS

(71) Applicant: GM GLOBAL TECHNOLOGY OPERATIONS LLC, Detroit, MI (US)

(72) Inventors: Sara R. Beyer, Clawson, MI (US); Fang Wang, Troy, MI (US); Tao Wang, Oakland Township, MI (US); Jeffrey Michael Setting, Clarkston, MI (US)

(73) Assignee: GM GLOBAL TECHNOLOGY OPERATIONS LLC, Detroit, MI (US)

(21) Appl. No.: 16/945,558

(22) Filed: Jul. 31, 2020

(51) Int. Cl. H02J 7/00

(52) U.S. Cl. CPC H02J 7/0014; H02J 7/00036; H02J 7/007182; H02J 7/0049; H02J 7/005

(57) ABSTRACT

A battery system with battery cell groups arranged in battery modules includes a controller network configured to monitor each module. The network includes multiple cell monitoring units (CMUs); each CMU electrically connected to one battery module and configured to process cell data for the respective battery cell groups. The network also includes multiple voltage sensors on each CMU—each sensor configured to detect voltage across one respective cell group, and multiple microchips—each microchip arranged on one CMU in communication with the respective voltage sensors. Each microchip is programmed with an algorithm configured to receive detected voltage data from the respective sensors at predetermined time intervals over a predetermined timeframe and store the voltage data. The algorithm is additionally configured to determine a discharge rate of each associated cell group using the stored data and determine degradation of each cell group using the determined respective discharge rate.

### INTRODUCTION

The present disclosure generally relates to a system and a method for module level diagnostics and performance prognostics of a multi-cell electrical energy storage system.

An electrical energy storage or battery system or array may include a plurality of battery cells in relatively close proximity to one another. A plurality of battery cells may be assembled into a battery stack or module, and a plurality of battery modules may be assembled into a battery pack. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific high-energy chemistries permitting such batteries to be repeatedly recharged and reused, therefore offering economic, environmental and ease-of-use benefits compared to disposable batteries.

Rechargeable batteries may be used to power such diverse items as toys, consumer electronics, and rotary electric machines, such as electric motors-generators, such as for powering motor vehicles. Depending on the particular configuration of the rotary subject electric machine, the battery cells may be recharged via an offboard charging station and/or via onboard regeneration. Battery cells may be depleted of charge during operation of the powered item or through self-discharge during storage. Self-discharge is a phenomenon in batteries in which internal chemical reactions reduce the stored charge of the battery without a connection between the electrodes or with an external circuit. Self-discharge decreases shelf life of batteries and causes them to initially have less than a full charge when actually put to use.

How fast self-discharge occurs in batteries is dependent on the battery type, it state of charge, ambient temperature, and other factors. Self-discharge is a chemical reaction, just as closed-circuit discharge is, and tends to occur more quickly at higher temperatures. Storing batteries at lower temperatures thus reduces the rate of self-discharge and preserves the initial energy stored in the battery. Self-discharge may also be affected by formation of a “passivation layer” on the battery electrodes over time, such as due to electrode material oxidation in the air.

### SUMMARY

A battery system includes a multi-cell rechargeable energy storage system (RESS) having a plurality of battery cell groups arranged in individual battery modules. The battery system also includes a battery controller network configured to monitor each of the battery modules. The battery controller network includes a plurality of cell monitoring units (CMUs), each respective one of the CMUs being electrically connected to a respective one of the battery modules and configured to process cell data for the respective battery module. The battery controller network also includes a plurality of voltage sensors mounted to or positioned on each CMU, each voltage sensor being configured to detect voltage across one respective cell group. The battery controller network additionally includes a plurality of microchips, each microchip being arranged on a respective one of the CMUs in communication with the respective voltage sensors.

Each microchip is programmed with a microchip algorithm inventory mode that, when executed by the respective microchip, is configured to interrogate the respective voltage sensor and retrieve data indicative of the detected voltages for the associated cell groups at predetermined time intervals over a predetermined timeframe. The microchip algorithm inventory mode is also configured to store the retrieved voltage data on the respective microchip. The microchip algorithm inventory mode is additionally configured to determine a discharge rate of each associated cell group using the stored voltage data. The microchip algorithm inventory mode is further configured to determine degradation of each associated cell group using the determined respective discharge rate.

The determination of degradation of the associated cell groups may be accomplished via comparison between the determined discharge rates of the associated cell groups.

The determination of degradation of the associated cell groups may be accomplished via comparison of the determined discharge rates of the associated cell groups with a threshold discharge rate.

The battery controller network may additionally include a plurality of temperature sensors. At least one of the plurality of temperature sensors may be mounted to or positioned on each of the CMUs and configured to detect temperatures of the associated cell groups. In such an embodiment, the microchip algorithm inventory mode may be additionally configured to interrogate the respective at least one of the plurality of temperature sensors and retrieve data indicative of the detected temperatures at predetermined time intervals over a predetermined timeframe. The microchip algorithm inventory mode may be also configured to store the retrieved temperature data on the respective microchip. The microchip algorithm inventory mode may be further configured to determine degradation of the associated cell groups using the stored temperature data.

The cell data for each respective cell group may include the retrieved voltage data and the retrieved temperature data. The microchip algorithm inventory mode may be additionally configured to predict degradation of each of the associated cell groups based on a trend in the respective cell data.

Multiple battery modules may be assembled into a battery pack. In such an embodiment, the battery controller network may additionally include a pack current sensor configured to detect an electrical current being supplied to the battery pack. The battery controller network may further include an electronic controller in communication with the plurality of CMUs and with the pack current sensor, and programmed with a battery pack artificial intelligence (AI) algorithm. The battery pack AI algorithm, when executed by the electronic controller, may be configured to predict degradation of each of the associated modules in the battery pack using the cell data and the battery pack current.

The battery controller network may additionally include an IT cloud server arranged remotely from the RESS and in wireless communication with the plurality of microchips. The IT cloud server may be configured to receive the cell data from the respective microchips and store the received cell data in an IT cloud database.

The IT cloud server may be programmed with an IT cloud artificial intelligence (AI) algorithm configured to select and match up cell groups using the respective cell data. Specifically, the inventory mode may be applied to standalone battery modules, such as during long-term storage at a service warehouse. Cell data collected during long-term storage may be used in vehicle service to match battery modules with similar cell discharge rates and other characteristics.

The inventory mode may be configured to interrogate the respective voltage sensors and retrieve data indicative of the detected voltage at predetermined time intervals over the predetermined timeframe when the associated cell groups are not being depleted of charge through a load or resides in a stored state.

The inventory mode may be configured to determine degradation of the associated cell groups using a predefined voltage threshold programmed into the microchip algorithm.

A method of monitoring and diagnosing, via a battery controller network, degradation of a multi-cell rechargeable energy storage system (RESS) having a plurality of battery cell groups arranged in individual battery modules, as described above, is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing a hybrid powertrain with multiple power-sources, and a battery system configured to generate and store electrical energy for supplying the electrical energy to the power-sources, according to the disclosure.

FIG. 2 is a circuit diagram of an individual battery module, including a plurality of battery cell groups connected in series and an associated cell monitoring unit (CMU), according to the disclosure.

FIG. 3 is a circuit diagram of the battery system shown in FIG. 1, the battery system including a multi-cell rechargeable energy storage system (RESS) with a plurality of battery cell groups arranged in individual battery modules shown in FIG. 2, and a battery controller network configured to monitor the battery modules, according to the disclosure.

FIG. 4 is a schematic illustration of individual battery modules, as shown in FIG. 2, depicted in long-term storage at a service warehouse and in communication with an IT cloud server for matching battery modules with similar cell characteristics, according to the disclosure.

FIG. 5 is a circuit diagram of the battery system shown in FIG. 1, the battery system depicted having a battery module being replaced by a service battery module, according to the disclosure.

FIG. 6 illustrates a method of monitoring and diagnosing degradation of the RESS shown in FIGS. 1-5.

### DETAILED DESCRIPTION

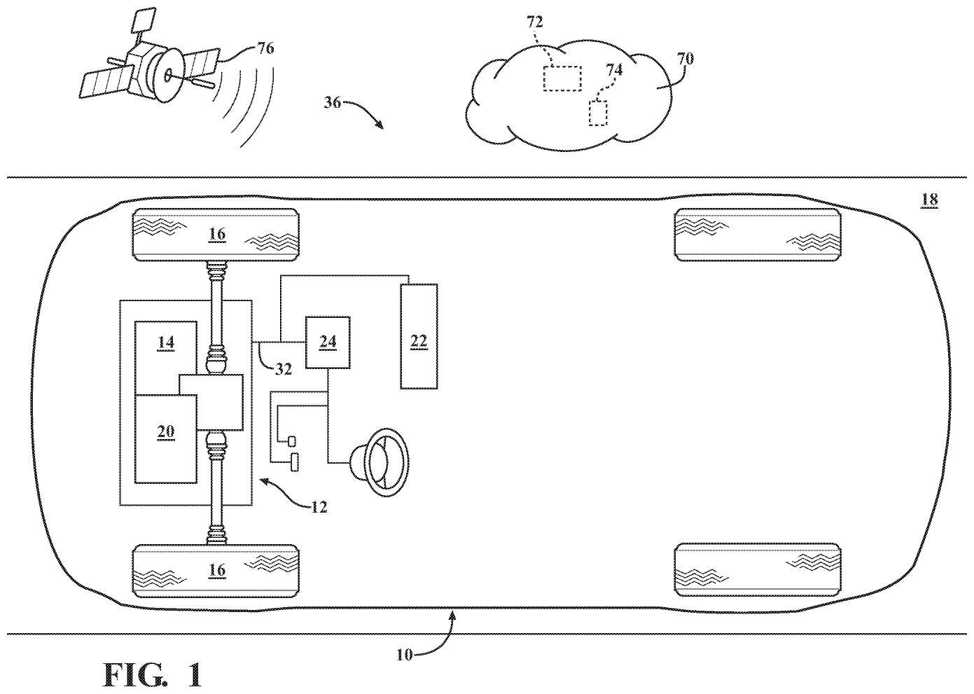

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator. As shown in FIG. 1, the powertrain 12 may also include an additional power-source 20, such as an internal combustion engine. The power-sources 14 and 20 may act in concert to power the vehicle 10.

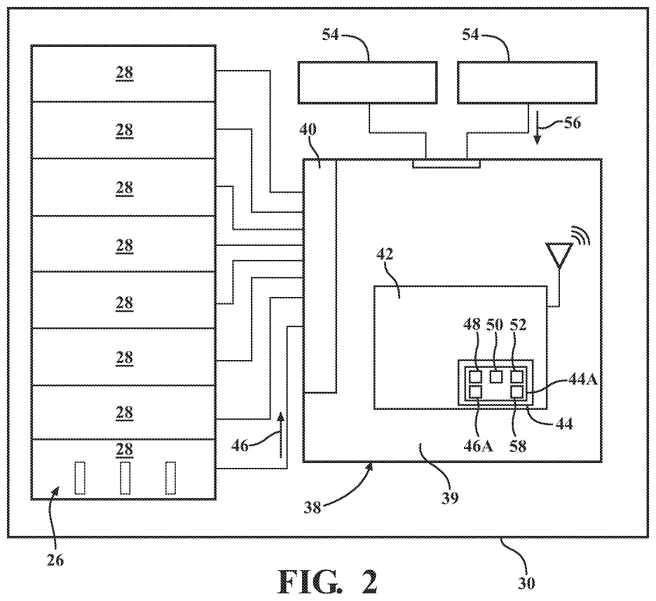

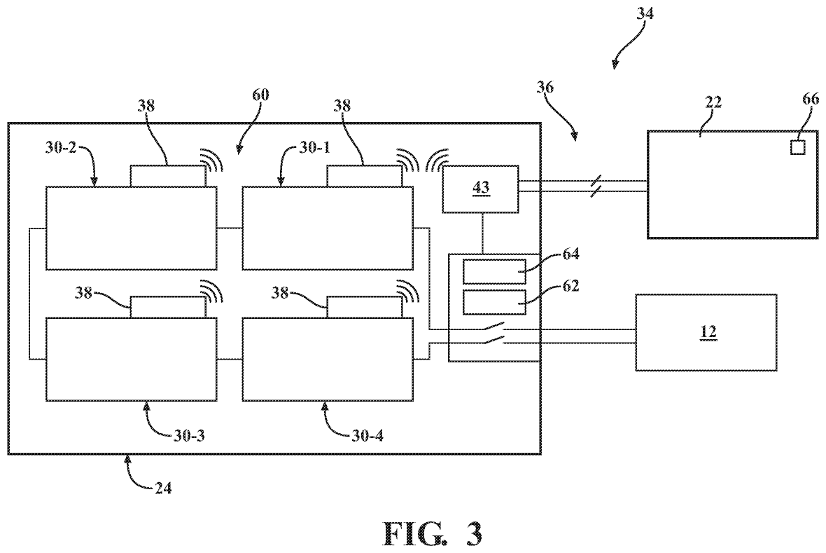

The vehicle 10 additionally includes a programmable electronic controller 22 and a multi-cell rechargeable energy storage system (RESS) 24. A general structure of the RESS 24 is schematically shown in FIG. 3. As shown in FIG. 2, a plurality of battery cells 26, the battery cells 26 may be initially combined into cell groups 28, where the individual cells may be arranged in parallel. The cell groups 28 may be subsequently organized into battery modules 30, such as modules 30-1, 30-2, 30-3, 30-4, where the individual cell groups are arranged, i.e., connected, in series (shown in FIG. 3). A plurality of modules 30 may then be arranged in a battery pack as part of the RESS 24. Although four modules 30-1, 30-2, 30-3, 30-4 are shown, nothing precludes the RESS 24 from having a greater number of such battery modules. Operation of the powertrain 12 and the RESS 24 may be generally be regulated by the electronic controller 22. The RESS 24 maybe connected to the power-sources 14 and 20, the electronic controller 22, as well as other vehicle systems via a high-voltage BUS 32 (shown in FIG. 1).

The RESS 24 is configured to generate and store electrical energy through heat-producing electro-chemical reactions for supplying the electrical energy to the power-sources 14 and 20. The electronic controller 22 may be programmed to control the powertrain 12 and the RESS 24 to generate a predetermined amount of power-source torque T, and various other vehicle systems. The electronic controller 22 may include a central processing unit (CPU) that regulates various functions on the vehicle 10, or be configured as a powertrain control module (PCM) configured to control the powertrain 12. In either of the above configurations, the electronic controller 22 includes a processor and tangible, non-transitory memory, which includes instructions for operation of the powertrain 12 and the battery system 24 programmed therein. The memory may be an appropriate recordable medium that participates in providing computer-readable data or process instructions. Such a recordable medium may take many forms, including but not limited to non-volatile media and volatile media.

Non-volatile media for the electronic controller 22 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection. Memory of the electronic controller 22 may also include a flexible disk, hard disk, magnetic tape, another magnetic medium, a CD-ROM, DVD, another optical medium, etc. The electronic controller 22 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 22 or accessible thereby may be stored in the memory and automatically executed to provide the required functionality of the powertrain 12 and the RESS 24.

The RESS 24 may also be part of a battery system 34 that includes a battery controller network 36. The battery controller network 36 is generally configured to monitor operation of the RESS 24, and specifically each of the battery modules 30. As shown in FIG. 3, the battery controller network 36 includes a plurality of cell monitoring units (CMUs) 38. Each of the cell groups 28 on a respective module 30 is physically wired to a particular CMU 38. Generally, a CMU is configured as a circuit board assembly and includes two separate integrated circuits—an application specific integrated circuit (ASIC) and a system on chip (SoC). An ASIC generally includes voltage sensor and temperature sensor [symbol] inputs for the particular module 30. The ASIC generally measures and reports sensor data at the request of a microprocessor. System on chip (SoC) generally includes a microprocessor in communication with the ASIC through a basic serial data connection, as well as onboard memory and a radio transceiver, as will be described in greater detail below. [symbol] Specifically, as schematically depicted in FIGS. 2 and 3, each respective one of the CMUs 38 is electrically connected to a respective one of the battery modules 30 and configured to process cell data for the respective cell groups 28. As shown in FIG. 2, the battery controller network 36 also includes a plurality of voltage sensors 40 mounted to or positioned on each CMU 38. Each voltage sensor 40 is electrically connected to terminals of a particular battery cell group 28 and configured to detect voltage across the subject cell group 28.

With continued reference to FIG. 2, the battery controller network 36 includes a plurality of system on chips (SoC) or microchips 42. Each microchip 42 is arranged on a respective one of the CMUs 38 in communication with, e.g., electrically connected via a printed circuit board (PCB) 39, to the respective voltage sensors 40. The microchips 42 are configured to gather cell data for the respective battery modules 30 and wirelessly transmit, via associated antennas, gathered cell data for the respective cell groups 28 to a battery radio frequency module (BRFM) 43. The BRFM 43 includes a respective microchip and an antenna for receiving wireless data from the CMUs 38. Each microchip 42 is also programmed with a microchip algorithm 44 which includes an inventory mode 44A that, when executed by the respective microchip, is configured to monitor the respective voltage sensors 40. Furthermore, the microchip algorithm 44 inventory mode 44A on each microchip 42 is configured to interrogate the respective voltage sensors 40.

The inventory mode 44A of each microchip 42 is specifically configured to retrieve data 46 indicative of the detected voltages for the associated cell groups 28 at predetermined time intervals t over a predetermined timeframe T. The inventory mode 44A of each microchip 42 is also configured to store the retrieved voltage data 46 on the respective microchip 42. The inventory mode 44A on each microchip 42 is additionally configured to determine a discharge rate DR of each associated cell group 28 using the voltage data 46 retrieved at predetermined time intervals t over the predetermined timeframe T The inventory mode 44A on each microchip 42 is further configured to determine or diagnose degradation 48 of each associated cell group 28 using the determined discharge rate DR of the respective cell groups. The inventory mode 44A may also be programmed to generate a sensory signal or alert 50, such as via setting a digital code or an audio-visual flag in the vehicle 10, indicative of the degradation 48 or a threshold discharge rate 52 having been reached by a particular cell group 28. Such an alert 50 may be retrieved by an authorized technician or communicated to a central authority including a database, such as an IT cloud server, which will be described in greater detail below.

The determination of degradation 48 of the associated cell groups 28 may be accomplished via comparison between the determined discharge rates DR of the associated cell groups 28. Alternatively, the determination of degradation 48 of the associated cell groups 28 may be accomplished via comparison of the determined discharge rates DR of the associated cell groups 28 with the threshold discharge rate 52. The battery controller network 36 additionally includes a plurality of temperature sensors, e.g., thermistors, 54. At least one of the plurality of temperature sensors 54 may be mounted to or positioned on each of the CMUs 38 to detect temperatures of the associated cell groups 28. As shown in FIG. 2, each CMU 38 may employ two individual temperature sensors 54, for example, proximate to distal ends of the module 30, for enhanced accuracy of the temperature data.

The microchip 44 algorithm inventory mode 44A may be additionally configured to interrogate the respective temperature sensors 54 and retrieve data 56 indicative of the detected temperatures at predetermined time intervals t over a predetermined timeframe T The algorithm inventory mode 44A may be also configured to store the retrieved temperature data 56 on the respective microchip 44. The algorithm inventory mode 44A may be further configured to determine degradation of the associated cell groups 28 using the stored temperature data 56. The inventory mode 44A may be configured to interrogate individual voltage sensors 40 and retrieve the data 46 indicative of the detected voltages at predetermined time intervals t over a predetermined timeframe T when the associated cell groups 28 of the RESS 24 are ether not being depleted of charge through a load or reside in a stored state. Alternatively, the inventory mode 44A may be configured to determine degradation of the associated cell groups 28 using a predefined voltage threshold 46A programmed into the microchip algorithm 44A.

In general, the temperature data 56 may be indicative of a runaway event affecting individual cell groups 28. The term “thermal runaway event” refers to an uncontrolled increase in temperature in a battery system. During a thermal runaway event, the generation of heat within a battery system or a battery cell exceeds the dissipation of heat, thus leading to a further increase in temperature. Generally, a thermal runaway event may be triggered by various conditions, including a short circuit within the cell, improper cell use, physical abuse, manufacturing defects, or exposure of the cell to extreme external temperatures.

The cell data for each respective cell group 28 may include the retrieved voltage data 46 and the retrieved temperature data 56. The microchip 44 algorithm inventory mode 44A may be additionally configured to determine a trend 58 in the respective cell data, for example via separate trend determinations for voltage and temperature data 46, 48, and predict degradation of each of the associated cell groups 28 based on the trend 58. When employed on the vehicle 10, multiple cell modules 30 may be assembled into a battery pack 60 (shown in FIG. 3). In the embodiment of the battery controller network 36 employed on the vehicle 10, the battery controller network may additionally include pack current sensor(s) 62 configured to detect an electrical current I being supplied to the battery pack 60, as well as pack voltage sensor(s) 64.

On the vehicle 10, the battery controller network 36 may include the vehicle electronic controller 22 in communication with the plurality of CMUs 38 and the pack current sensors 62, 64, such as via low-voltage lines and an isolated communications pathway. The vehicle electronic controller 22 may be programmed with a battery pack artificial intelligence (AI) algorithm 66 that, when executed by the electronic controller, is configured to predict degradation of each of the associated modules 30 in the battery pack 60 using the cell data and battery pack electrical current I. Specifically, the AI algorithm 66 may be configured to assess incoming data from the respective voltage sensors 40, temperature sensors 54, pack current sensor(s) 62, and pack voltage sensor(s) 64.

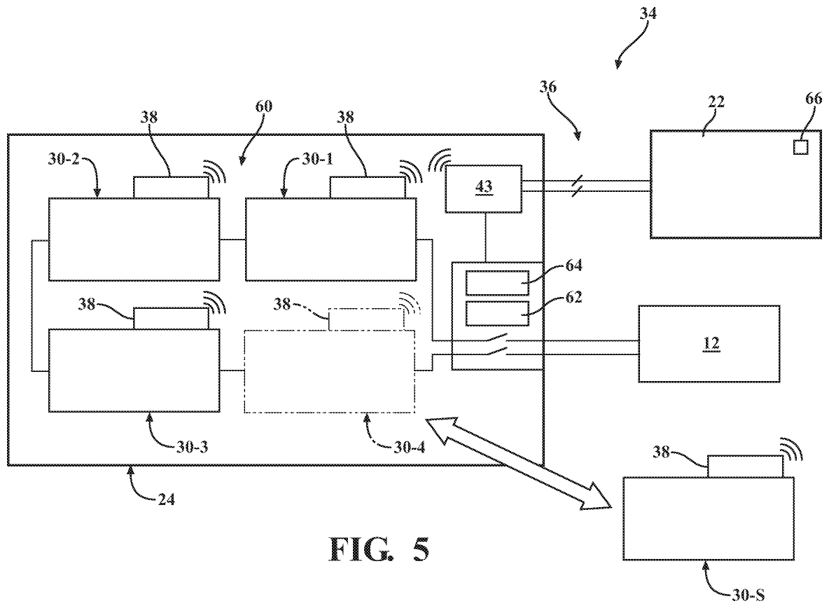

With resumed reference to FIG. 1, the battery controller network 36 may additionally include an external IT cloud server 70 arranged remotely from the RESS 24, as well as the vehicle 10, and in wireless communication with the vehicle telematics via the electronic controller 22. The IT cloud server 70 may be in wireless communication with multiple electronic controllers 22 on multiple vehicles, such as the vehicle 10, and configured to receive cell data from respective microchip(s) 44 and store the received cell data in an IT cloud database 72. The IT cloud server 70 is programmed with an IT cloud artificial intelligence (AI) algorithm 74 configured to sort modules 30, and select and match up cell groups 28 using the respective cell data. As shown in FIG. 5, the IT cloud server 70 may assist with matching battery modules 30 of the vehicle 10 with available replacement cell modules, as described below and shown in FIG. 5.

Generally, modules employing cell groups having comparable levels of degradation perform more effectively. The AI algorithm 74 may be specifically configured to assess incoming data from the respective voltage sensors 40, temperature sensors 54, pack current sensor(s) 62, and pack voltage sensor(s) 64 to evaluate individual modules from multiple vehicles. Requisite communication between the respective microchips 44 of individual vehicles and the IT cloud server 70 may be cellular or via wireless local area networking (Wi-Fi) facilitated by a cloud edge residing on a cellular base station (not shown) for reduced latency, or via an earth-orbiting satellite 76 (shown in FIG. 1).

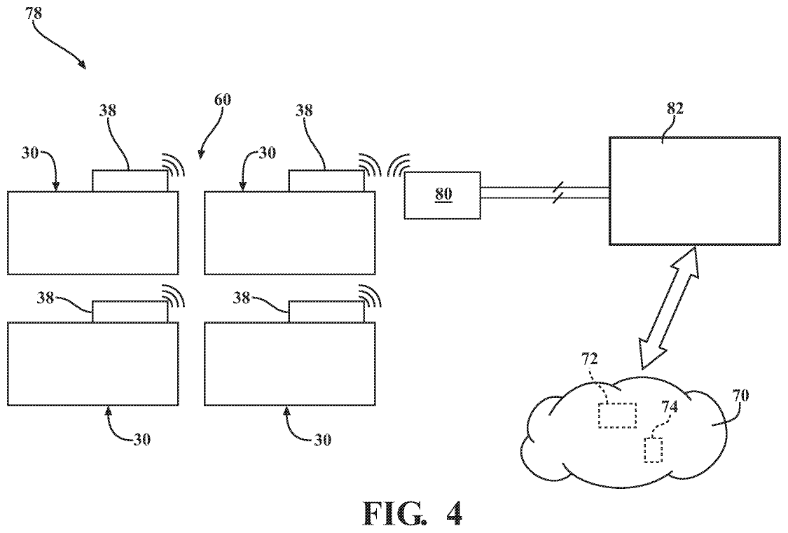

With reference to FIG. 4, a plurality of individual, stand-alone cell modules 30 may be kept in a warehouse 78 for long-term storage, for example, for service and retrofit of vehicles, such as the vehicle 10. A wireless controller 80, configured similar to the BRFM 43 and in wireless communication with the IT cloud server 70, may be used along with the service database 72 or a stand-alone service warehouse IT server 82 to collect, store, and sort cell data such as self-discharge rate DR over time T. In a service application, a single cell module 30 of a particular vehicle's RESS 24 may be replaced with a service cell module 30-S exhibiting similar cell performance (shown in FIG. 5), such as cell discharge rates and other characteristics, as determined by the AI algorithm 74, in order to maximize service life of the subject RESS.

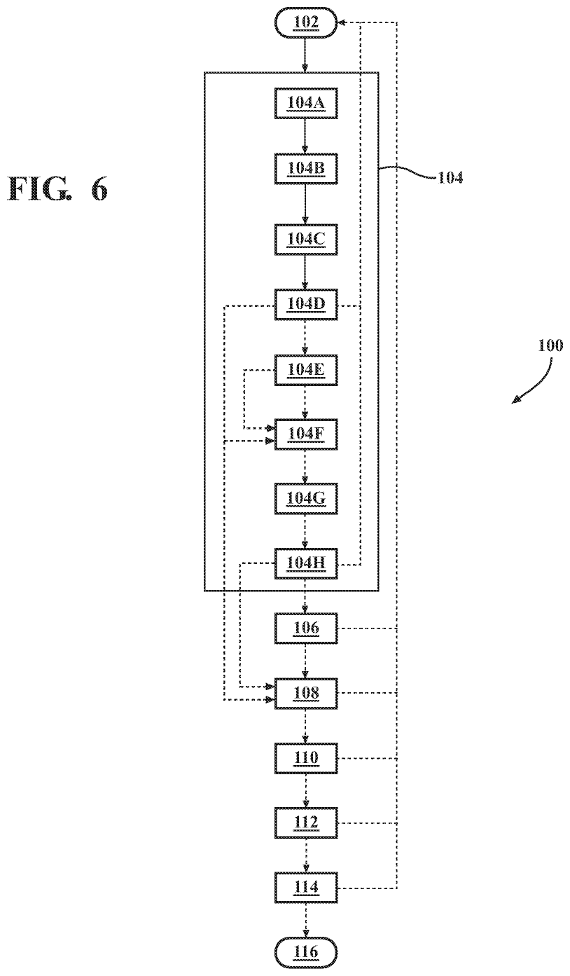

A method 100 of monitoring and diagnosing degradation of cell groups 28 is shown in FIG. 6, and described below with reference to the structure shown in FIGS. 1-5. Method 100 commences in frame 102 with detecting voltage across each of the cell groups 28 via a respective one of a plurality of voltage sensors 40 in the battery module 30. Following frame 102, the method advances to block frame 104. In block frame 104, the method includes executing the algorithm inventory mode 44A, via each of a plurality of microchips 44. As described with respect to FIGS. 1-5, the microchips 44 are arranged on a respective one of the CMUs 38, in communication with the respective voltage sensors 40.

Executing the microchip algorithm inventory mode 44A, in frame 104A, specifically includes interrogating the respective voltage sensors 40 and retrieving data 46 indicative of the detected voltage for the associated cell groups 28 at predetermined time intervals t over the predetermined timeframe T From frame 104A, the method moves on to frame 104B, where executing the microchip algorithm inventory mode 44A includes storing the retrieved voltage data 46 on the respective microchip 44. After frame 104B the method proceeds to frame 104C, where executing the microchip algorithm inventory mode 44A includes determining the discharge rate DR of each associated cell group 28 using the stored data 46.

In frame 104C, the inventory mode 44A may be configured to interrogate individual voltage sensors 40 and retrieve the data 46 indicative of the detected voltages at predetermined time intervals t over a predetermined timeframe T when the associated cell groups 28 in the RESS 24 are ether not being depleted of charge through a load or reside in a stored state. Alternatively, the inventory mode 44A may be configured to determine degradation of the associated cell groups 28 using the predefined voltage threshold 46A programmed into the microchip algorithm 44A, as described with respect to FIGS. 1-5. Following frame 104C, the method proceeds to frame 104D. In frame 104D, the method includes determining degradation 48 of each associated cell group 28 using the determined respective discharge rate DR. After the determination of the discharge rates DR for each respective cell group 28, the method may advance to frame 104E, where the method includes setting the digital code or the audio-visual flag 50 via the electronic controller 22 in the vehicle 10, indicative of degradation 48 or the threshold discharge rate 52 having been reached via a particular cell group 28. Either from frame 104D or frame 104E, the method may advance to frame 104F.

In frame 104F, the method may include interrogating the respective temperature sensor(s) 54 and retrieve data 56 indicative of the detected temperatures at predetermined time intervals t over the predetermined timeframe T. From frame 104F, the method may move on to frame 104G, where the method includes storing the retrieved temperature data 56 on the respective microchip 44. After frame 104G, the method may move on to frame 104H, where the method includes determining degradation of the associated cell groups 28 using the stored temperature data 56. Following either of the frames 104D or frame 104H, the method may proceed to frame 106. In frame 106, the method includes predicting, via the microchip algorithm inventory mode 44A, degradation of each of the associated cell groups 28 based on the assessed trend 58 in the respective cell data.

Following either of the frames 104D, 104H, or 106, the method may proceed to frame 108. In frame 108, the method includes detecting, on the vehicle 10 via the pack current sensor 62, the electrical current I being supplied to the battery pack 60. After frame 108, the method may move on to frame 110. In frame 110 where the method additionally includes predicting, via the battery pack AI algorithm 66 executed by the vehicle electronic controller 22, degradation of each of the associated modules 30 in the battery pack using the cell data and the battery pack current I. From frame 104D, 104H, 106, 108, or 110, the method may move on to frame 112, where the method includes receiving the cell data from the respective microchips 44 and storing the received cell data in the IT cloud database 72 via the IT cloud server 70 in wireless communication with the plurality of microchips 44.

After frame 112, the method may move on to frame 114. In frame 114 where the method includes selecting and matching up cell groups 28 using the respective cell data via the IT cloud AI algorithm 74 programmed into the IT cloud server 70, for example as described with respect to FIG. 4. It is envisioned that the method 100 enables monitoring and diagnosing, and optionally predicting, the degradation of the RESS 24, for example when the RESS is supplying electrical current, or during self-discharge, i.e., when the RESS is being depleted of charge during storage or otherwise not supplying current to the electrical device, such as the power-source 14. Following either of the frames 104D, 104H, 106, 108, 110, 112, or 114 the method may loop back to frame 102 for another control cycle of monitoring and diagnosing degradation of RESS 24 via the battery controller network 36. Alternatively, the method may conclude in frame 116.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery system comprising:
a multi-cell rechargeable energy storage system (RESS) having a plurality of battery cell groups arranged in individual battery modules; and
a battery controller network configured to monitor each of the battery modules, the battery controller network including:
a plurality of cell monitoring units (CMUs), each respective one of the CMUs being electrically connected to a respective one of the battery modules and configured to process cell data for the respective battery cell groups;
a plurality of voltage sensors mounted to or positioned on each CMU, each voltage sensor being configured to detect voltage across one respective cell group; and
a plurality of microchips, each microchip being arranged on a respective one of the CMUs in communication with the respective voltage sensors, and programmed with a microchip algorithm inventory mode that, when executed by the respective microchip, is configured to:
interrogate the respective voltage sensors and retrieve data indicative of the detected voltages for the associated cell groups at predetermined time intervals over a predetermined timeframe;
store the retrieved voltage data on the respective microchip;
determine a discharge rate of each associated cell group using the stored data; and
determine degradation of each associated cell group using the determined respective discharge rate.

2. The battery system of claim 1, wherein the determination of degradation of the associated cell groups is accomplished via comparison between the determined discharge rates of the associated cell groups.

3. The battery system of claim 1, wherein the determination of degradation of the associated cell groups is accomplished via comparison of the determined discharge rates of the associated cell groups with a threshold discharge rate.

4. The battery system of claim 1, wherein:
the battery controller network additionally includes a plurality of temperature sensors, at least one of the plurality of temperature sensors being mounted to or positioned on each of the CMUs and configured to detect temperatures of the associated cell groups; and
the microchip algorithm inventory mode is additionally configured to:
interrogate the respective at least one of the plurality of temperature sensors and retrieve data indicative of the detected temperatures at predetermined time intervals over a predetermined timeframe;
store the retrieved temperature data on the respective microchip; and
determine degradation of the associated cell groups using the stored temperature data.

5. The battery system of claim 4, wherein:
the cell data for each respective cell group includes the retrieved voltage data and the retrieved temperature data; and
the microchip algorithm inventory mode is additionally configured to predict degradation of each of the associated cell groups based on a trend in the respective cell data.

6. The battery system of claim 5, wherein:
multiple battery modules are assembled into a battery pack; and
the battery controller network additionally includes:
a pack current sensor configured to detect an electrical current being supplied to the battery pack; and
an electronic controller in communication with the plurality of CMUs and with the pack current sensor, and programmed with a battery pack artificial intelligence (AI) algorithm that, when executed by the electronic controller, is configured to predict degradation of each of the associated modules based on a trend in the respective cell data of each of the plurality of cell groups in the battery pack using the cell data and the battery pack current.

7. The battery system of claim 5, wherein the battery controller network additionally includes an IT cloud server arranged remotely from the RESS and in wireless communication with the plurality of microchips to receive the cell data from the respective microchips and store the received cell data in an IT cloud database.

8. The battery system of claim 7, wherein the IT cloud server is programmed with an IT cloud artificial intelligence (AI) algorithm configured to select and match up cell groups using the respective cell data.

9. The battery system of claim 1, wherein the inventory mode is configured to interrogate the respective voltage sensors and retrieve data indicative of the detected voltage at predetermined time intervals over the predetermined timeframe when the associated cell groups are not being depleted of charge through a load or resides in a stored state.

10. The battery system of claim 1, wherein the inventory mode is configured to determine degradation of the associated cell groups using a predefined voltage threshold programmed into the microchip algorithm.

11. A method of monitoring and diagnosing, via a battery controller network, degradation of a multi-cell rechargeable energy storage system (RESS) having a plurality of battery cell groups arranged in individual battery modules, the method comprising:
detecting voltage across each of the plurality of cell groups via a respective one of a plurality of voltage sensors, wherein the plurality of voltage sensors is mounted to or positioned on each of a plurality of cell monitoring units (CMUs) in the battery controller network, and wherein each respective CMU is electrically connected to a respective one of the battery modules and configured to process cell data for the respective battery cell groups; and
executing a microchip algorithm inventory mode, via each of a plurality of microchips arranged on a respective one of the CMUs, in communication with the respective voltage sensors, and programmed with a microchip algorithm having the inventory mode, including:
interrogating the respective voltage sensors and retrieving data indicative of the detected voltage for the associated cell groups at predetermined time intervals over a predetermined timeframe;
storing the retrieved voltage data on the respective microchip;
determining a discharge rate of each associated cell group using the stored data; and
determining degradation of each associated cell group using the determined respective discharge rate.

12. The method of claim 11, wherein the determination of degradation of the associated cell groups is accomplished via comparing between the determined discharge rates of the associated cell groups.

13. The method of claim 11, wherein the determination of degradation of the associated cell groups is accomplished via comparing the determined discharge rates of the associated cell groups with a threshold discharge rate.

14. The method of claim 11, wherein:
the battery controller network additionally includes a plurality of temperature sensors, and at least one of the plurality of temperature sensors is mounted to or positioned on each of the CMUs, the method further comprising detecting temperatures of the associated cell groups; and
executing the microchip algorithm inventory mode additionally includes:
interrogating the respective at least one of the plurality of temperature sensors and retrieve data indicative of the detected temperatures at predetermined time intervals over a predetermined timeframe;
storing the retrieved temperature data on the respective microchip; and
determining degradation of the associated cell groups using the stored temperature data.

15. The method of claim 14, wherein the cell data for each respective cell group includes the retrieved voltage data and the retrieved temperature data, further comprising predicting, via the microchip algorithm inventory mode, degradation of each of the associated cell groups based on a trend in the respective cell data.

16. The method of claim 15, wherein multiple battery modules are assembled into a battery pack, the method further comprising:
detecting, via a pack current sensor, an electrical current being supplied to the battery pack; and
predicting, via a battery pack artificial intelligence (AI) algorithm executed by an electronic controller in communication with the plurality of CMUs and with the pack current sensor, degradation of each of the associated modules in the battery pack using the cell data and the battery pack current.

17. The method of claim 15, further comprising receiving the cell data from the respective microchips and storing the received cell data in an IT cloud database via an IT cloud server arranged remotely from the RESS and in wireless communication with the plurality of microchips.

18. The method of claim 17, further comprising
selecting and matching up cell groups using the respective cell data via an IT cloud artificial intelligence (AI) algorithm programmed into the IT cloud server.

19. The method of claim 11, wherein the inventory mode is configured to interrogate the respective voltage sensors and retrieve data indicative of the detected voltage at predetermined time intervals over the predetermined timeframe when the associated cell groups are not being depleted of charge through a load or resides in a stored state.

20. The method of claim 11, wherein the inventory mode is configured to determine degradation of the associated cell groups using a predefined voltage threshold programmed into the microchip algorithm.
